(19) United States
(12) Patent Application Publication
(10) Pub. No.: US 2013/0180514 A1
(43) Pub. Date: Jul. 18, 2013

(54) DEVICE AND METHOD FOR SETTING UP A CONTROL ELEMENT FOR THE GAS PRESSURE OF A COKE OVEN CHAMBER WITHOUT EXPANSION-INDUCED DEVIATIONS OF THE CONTROL ASSEMBLY

(71) Applicants: Kerstin Überschär, Gladbeck (DE); Frank Krebber, Essen (DE); Helmut Schulte, Essen (DE)

(72) Inventors: Kerstin Überschär, Gladbeck (DE); Frank Krebber, Essen (DE); Helmut Schulte, Essen (DE)

(73) Assignee: THYSSENKRUPP UHDE GMBH, Dortmund (DE)

(21) Appl. No.: 13/823,231

(22) PCT Filed: Sep. 26, 2011
(86) PCT No.: PCT/EP2011/004795

§ 371 Date: Mar. 25, 2013

(30) Foreign Application Priority Data
Sep. 30, 2010 (DE) 10 2010 047 025.2

(51) Int. Cl. F16K 1/36

(52) U.S. Cl. CPC F16K 1/36
USPC 126/80

(57) ABSTRACT

A device for setting up a control element for controlling the gas pressure of a coke oven chamber without expansion-induced deviations of the control assembly, which deviations in comparable devices from the prior art result from high temperatures and temperature differences in coke oven chambers during operation. The device and the method prevent water used for shutting off, cooling and removing water-soluble impurities from riser pipes from flowing out of the control element in an uncontrolled manner. Also disclosed is a method for controlling the gas pressure of a coke oven chamber using the device, wherein the pressure in the coke oven chamber relative to the collecting main conducting raw gas is controlled by using the control element without expansion-induced deviations of the regulating assembly.

The invention relates to a contrivance for providing a control device for controlling the gas pressure in a coke-oven chamber without expansion-induced deviations from the control arrangement resulting during operation from the high temperatures and temperature differences of coke-oven chambers in similar devices according to the state of the art. The inventive contrivance and the method serve to prevent that water which is used to seal off, cool and separate water-soluble impurities from standpipes leaves the control device in an uncontrolled manner. The invention also relates to a method applied to control the gas pressure of a coke-oven chamber by means of the aforementioned contrivance, the pressure of the coke-oven chamber being controlled against the crude gas-conducting collecting main by means of the aforementioned control device without expansion-induced deviation from the control arrangement.

In the operation of coke-oven chambers a coking gas is produced, which normally enters the gas compartment above the coke cake, from where it is conveyed to downstream treatment. The amount of coking gas obtained depends on the time-dependent course of the coking process. Usually the time-dependent course of the gas output of a coke-oven chamber during the coking cycle is quite predictable. As it fails to be constant but rather depends on the current state of the coking process, the pressure in the gas compartment of the coke-oven chamber is subject to fluctuations in the course of the coking process.

It is, however, intended to maintain the gas pressure in the gas compartment above the coke-oven chamber as constant as possible throughout the whole coking period, to allow more efficient control of the coking process and improvement of the downstream treatment of the coking gas. There are some configurations that allow for an increase of the gas pressure towards the end of the coking cycle. It is particularly intended to keep the gas pressure in the coke-oven chamber continuously at a level that prevents ambient air from being sucked into the oven, which can be achieved by ensuring a constant slight overpressure as compared to the outside atmosphere by adequate control of the gas pressure in the entire coke-oven chamber.

For this reason there are control devices suitable to maintain a constant pressure or to control the pressure in a coke-oven chamber throughout the entire coking process. In an exemplary configuration for this purpose, the coking gas to be discharged from the coke-oven chamber is passed through a water volume provided as a dip seal so that the gas pressure in the coke-oven chamber is controlled by the height and the pressure of the dip seal. Located above the dip seal is the gas compartment of a so-called gas collecting main representing a collecting tank for the discharged coking gas and permanently containing a bottom volume of water from the overflowing water of the float cup. As such design allows for the use of different pressures in the coke-oven chamber and in the gas collecting main, it is possible to control the coke-oven chamber pressure individually in dependence of the carbonisation progress.

EP 649455 B1 teaches an exemplary design and the related process. The gas compartment of the coke-oven chamber is connected to a standpipe extending into a curved standpipe gooseneck which in turn immerses into a cup-shaped end flap. This cup-shaped end flap which is also referred to as pivoting cup is filled with water from a carbon slurry line. An adjustable gate valve is operated by an actuator, which keeps the water in the pivoting cup at a precisely controlled level depending on the pressure conditions in the coke-oven chamber. As this device can be provided for each individual coke-oven chamber, it is thus possible to control the gas pressure of each individual coke-oven chamber and control or keep constant the output of coking gas over the time for the whole coke-oven battery or coke oven bank. The immersing end of the stand-pipe gooseneck is shaped in a special form to prevent that an edge in parallel to the water level will cause overshooting of the pressure control and pulsation of the dip seal.

During the operation of the coke-oven chambers high temperatures occur which, in addition, are submitted to fluctuations in the time-dependent course of the coking process. Equally the coking gas which is sucked into the gas collecting main via the control device is of different temperatures depending on the progress of the coking process. The temperature variations can be significant due to the characteristic features of the coking process. The consequence is expansion and misalignment of the metal components of the gas-conducting or gas pressure-controlling metal members of the coke-oven chamber. Such expansion and misalignment result in deviations of the gas-conducting components from their control arrangement. These lead to leaks in the gas and water flow of the gas-conducting and water-conducting components of coke-oven chambers and of the pressure-controlling devices.

This is problematic especially with regard to the pressure control of the coking gas, which is carried out by valves and water-conducting control devices, as it is normally absolutely necessary to ensure reliable control of the coke-oven chamber pressure. Misalignment and expansion of gas-conducting and water-conducting components of coke-oven chambers also involve a safety risk since these may be the reason for the entry of air into the coking gas which still has a calorific value. For this reason there are devices which serve to compensate expansions and misalignments occurring in the course of a coking cycle.

Patent document DE 102009023222.2 not yet published at the time of the application teaches a contrivance used to compensate deviations from the coaxial set-up of the components of a control arrangement, the control arrangement consisting of control device, crown pipe and float cup and used to control the gas pressure of a coke-oven chamber, the control arrangement including a float cup with dip seal sealing the gas compartment of a coke-oven chamber against the gas collecting main and/or downstream equipment items, and the height of the water level of the dip seal figuring as a regulating means to control the gas pressure, and the control arrangement also including a dip pipe which is designed with a specially formed crown tube at the end which dips into the water of the float cup and includes a control device for controlling the water level. The invention ensures that deviations from the concentric alignment of the control device are prevented and travelling of the sealing plug of the control valve is always along the centreline and hermetical into the provided sealing seat of the sealing plug of the float cup.

The contrivance controls the gas pressure in the coke-oven chamber and compensates the temperature-induced deviations by providing flexible suspension of the float cup by means of deflectable elements so that the float cup can be moved in horizontal direction and by providing guiding elements at the outer side of the crown pipe or on the inside of the float cup, these guiding elements being used to guide the crown pipe in the float cup and being located between crown pipe and float cup and, by their size, allowing exactly defined mobility within the float cup. In this way it is possible to prevent undesirable flow of water from the float cup into the gas-conducting collecting main which forms by misalignment of the sealing plug. Furthermore it is thus possible to prevent air from entering the coke-oven chamber or the gas-conducting collecting main.

By this arrangement, the standpipe system with the gooseneck may, however, move significantly upwards in the course of the operating cycle due to thermal expansion. During operation of the coke-oven chamber with the respective control device the initially aligned float cups are usually not re-aligned according to the respective expansion so that the notches of the crown pipe do no longer correspond in the desired ratio to the water outlet ports of the control device. The consequence is that in the course of the operating cycle the gas flow into the gas collecting main can no longer be reliably controlled or calculated.

It is therefore the aim to provide for a contrivance which controls the gas pressure in coke-oven chambers by regulating the flow into a gas-conducting collecting main by means of a water-containing float cup and compensates temperature-induced expansions or misalignments to prevent unwanted gas and water flow into the gas collecting main, with the contrivance allowing to do without a realignment of the control arrangement so that a maintenance-free and durable control arrangement of the control device for controlling the gas flow is achieved.

The present invention achieves this aim by using a control device rising from a coke-oven chamber via a standpipe with connected gooseneck and dip pipe leading vertically downward with connected crown pipe, a dip seal, with the height of the water level representing a means to control the gas pressure, a sealing plug which regulates the water level in the float cup, with the float cup and the dip pipe being provided with a fixed enclosure forming an annular space with the float cup, the annular space being suited to serve as an overflow for the water from the float cup into the gas collecting main and as passage for the gas into the gas collecting main, and the enclosure being provided with a notched rim which dips into a circular embracing dip seal on top of the gas collecting main so that expansions or misalignments between gas collecting main and enclosure can be compensated.

This contrivance prevents any misalignment or expansion between dip pipe and float cup by temperature differences, whereas the expansions caused between gas collecting main and standpipe with gooseneck are absorbed by a notched rim which extends into a dip seal. In this way the water and gas-flow controlling part of the control device remains maintenance-free in one and the same arrangement. This also prevents unwanted gas or water passage into the gas collecting main.

Especially claimed is a contrivance for providing a control device for controlling the gas pressure in a coke-oven chamber without expansion-induced deviations from the control arrangement, including
a standpipe which rises vertically from a coke-oven chamber and is connected to a gooseneck diverting laterally from the standpipe and going over vertically downwards into a dip pipe, the end of which is provided as a crown pipe with indented or notched rims and an inlet for water, and
a float cup with downward tapered bottom, the cup being provided with a water outlet departing from the bottom at its lower end and having an open top, and
a sealing plug travelling through the dip pipe and sealing the discharge from the dip seal of the float cup into the gas collecting main arranged beneath in a controlled manner, and
a crude gas-conducting collecting main into which the water from the float cup flows by overflow or opening of the sealing plug,
   and which is characterised in that
the float cup and the dip pipe with the crown pipe at its end are contained in a fixed enclosure which forms an annular space with the float cup, this annular space being suited as overflow for the water and gas passage from the float cup into the gas collecting main, and
the enclosure is provided with a notched rim extending into a circular embracing dip seal on top of the gas collecting main so that expansions or misalignments between the gas collecting main and the enclosure can be compensated.

The enclosure or the enclosing body can be made of optional material. It is most favourably made of cast iron or a cast steel. In a more simplified embodiment it can also be formed from a sheet metal body.

In an exemplary fashion, a flanged connection serves to connect the enclosure to the dip pipe. This involves the advantage that the enclosure can be removed with the float cup and the latter is thus easily accessible for inspection purposes. The enclosure can be connected to the dip pipe in any way desired. A permanent welding connection, for example, is also conceivable. The arrangement of such connection is optional as well. The enclosure may, for example, be suspended vertically in the middle of the dip pipe but it may also be fixed directly underneath the standpipe gooseneck. The enclosure may, for example, be suspended concentrically in relation to the dip pipe ensuring the same distance to the latter on any plane and in all directions. The enclosure can also be of any shape, preferably, however, it is conical towards the bottom and ends in a section projecting beyond the end of the float cup.

For vertical suspension, the float cup can be connected to the dip pipe or the enclosure. Suspension can be implemented by means of rods, flanges or metal sheets. For vertical fixing, however, the float cup can also be suspended by means of holding rods to an annular disk of the dip pipe. In that case, the holding rods are attached to the upper end of the annular disk which surrounds the dip pipe at an optional point. The number of holding rods is optional but amounts to at least three. The holding rods are made of optional material. In an exemplary mode they can be in the form of steel pins, they may also be in the form of metal bolts, pipe sections or cast ribs. They are advantageously fixed by means of screwed unions or rivets.

According to an embodiment of the invention, the upper end of the gas-conducting collecting main is equipped with a gas flap which is located at the upper end of the gas collecting main and by which the gas collecting main can be shut off against the enclosure and the float cup. This valve can be of optional design. In an exemplary embodiment, it may be in the form of a simple flap suspended at the upper end of the gas collecting main by means of a pivot bearing which tilts upwards for closure. However, it may also be in the form of a laterally tilting flap. The installation of a flap ensures that the gas collecting main can be shut off when the float cup is removed or in the case of an operational failure so that air is prevented from entering the gas collecting main. An entry of air into the crude gas-conducting collecting main is undesirable for process and safety reasons.

The sealing plug can be of optional design. The preferred design, however, includes a siphon, an adjustable gate valve, and a discharge pipe, with the adjustable gate valve serving to control the water level in the float cup, or discharge through the discharge pipe into the gas collecting main, which can be controlled via the position of a gate valve, which can be closed vertically and which is included in the sealing plug, and a related operating mechanism. The operating mechanism typically consists of a rod connected to an actuator.

Also claimed is a method by which the pressure of the coke-oven chamber can be controlled against the pressure difference of the gas collecting main by using the aforementioned control device for controlling the gas pressure of a coke-oven chamber without expansion-induced deviations from the control arrangement. This process uses the aforementioned contrivance as control device. Especially claimed is a method for the operation of a coke-oven battery or coke-oven bank including a plurality of coke-oven chambers, a crude-gas conducting crude-gas collecting main and throttle devices installed in the crude-gas collecting main for individual control of the gas pressure in the coking chambers, in which
each of the throttle devices is provided with a water-supplied float cup with sealable outlet, and
the coking chambers are connected to the crude-gas collecting main via gas lines which end as dip pipes in the float cups of the throttle devices, and
throttle devices are used which are provided with an overflow for controlling the liquid level in the float cup, the overflow being vertically adjusted by means of an actuator,
   and which is characterised in that
the pressure in the coke-oven chamber is controlled by a control device for controlling the gas pressure in a coke-oven chamber without expansion-induced deviations of the float cup and the throttle device from the control arrangement, with expansions towards the gas collecting main being compensated by a circular notched rim of an enclosure dipping into a dip seal.

The method can also be automated. For this purpose the pressure of at least one coke-oven chamber is controlled by means of a measuring device which adjusts the water supply into the float cup in dependence of the inside pressure of the coke-oven chamber. Such automation can be implemented for one coke-oven chamber but is preferably implemented for several or all coke-oven chambers of a coke-oven bank or coke-oven battery.

The method and the inventive contrivance are typically used for the operation of conventional coke ovens.

In an exemplary configuration, the annular dip seal which serves to compensate expansions and misalignments between gas collecting main and standpipe and/or dip pipe, is filled with water. However, the dip seal can also be filled with bitumen which may be requested for high-temperature applications. Furthermore, the dip seal can be provided with a filling containing a silicone compound.

The invention involves the advantage of providing a contrivance controlling the gas pressure in a coke-oven chamber via a variable water level in a float cup, with the dip pipe which leads out of the coke-oven chamber plus the related control device for the water level and for the gas pressure never deviating from the specified control arrangement despite expansion or misalignment action and not requiring any maintenance-intensive re-adjustments. The invention involves the additional advantage that the gas collecting main can be fitted with a gas flap. If a gas flap is provided, the gas collecting main can be shut off for the removal of the float cup or in the event of an operating failure so that no air enters the gas collecting main.

The invention is illustrated by means of three drawings, these drawings being only exemplary configurations for the design of the inventive contrivance and not being limited to these examples.

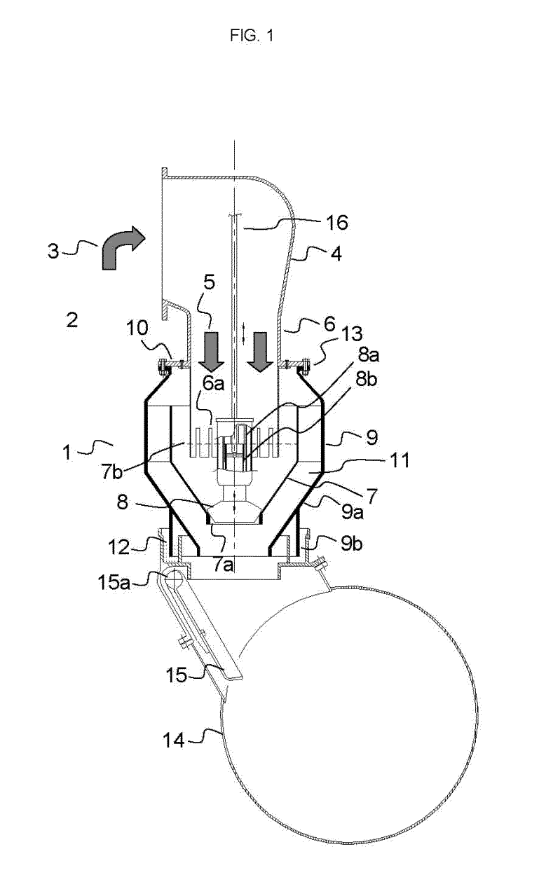

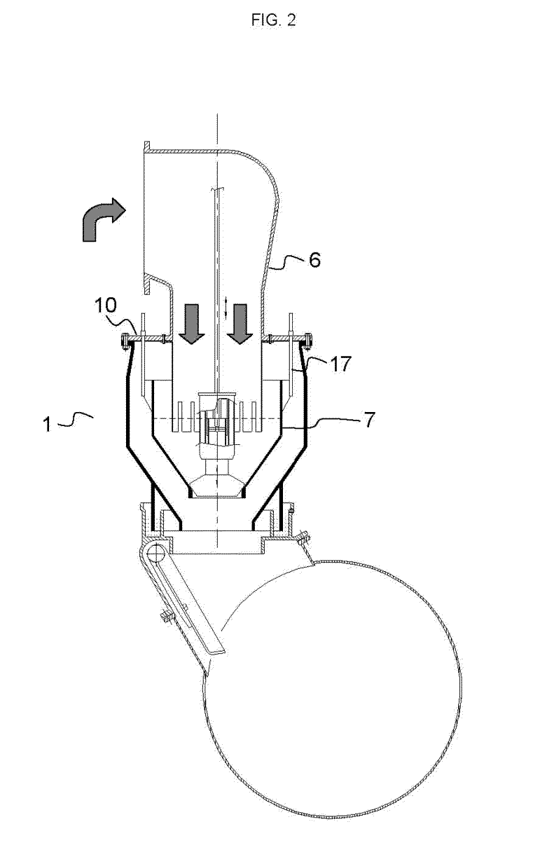

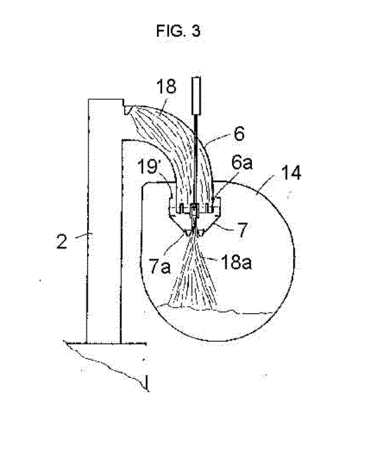

FIG. 1 shows an inventive contrivance where the float cup is directly attached to the enclosure and the dip pipe. FIG. 2 shows an inventive contrivance where the float cup is fixed via holding rods to a horizontally arranged annular disk attached to the dip pipe. FIG. 3 shows a state-of-the-art contrivance which is mounted on the coke-oven chamber.

FIG. 1 shows an inventive contrivance (1) for controlling the coke-oven chamber pressure including a standpipe (2) which is not represented here and serves to discharge the coking gases (3) from a coke-oven chamber via a connected goose-neck (4), with only the gooseneck (4) being represented, that is connected to the standpipe (2) and directing the coking gases (3) by 180° in downward direction (5). The gooseneck (4) is connected to the downward dip pipe (6) which ends in a crown pipe (6a) with indented or notched rims. The dip pipe (6) with the crown pipe (6a) at its end extends into a float cup (7) with conical bottom directed downwards to a water outlet (7a) and having a variable water level (7b). A sealing plug (8) extending into the sealing end of the float cup (7) and sealing the water outlet (7a) travels along the centreline of the dip pipe (6). According to the invention, the dip pipe (6) and the float cup (7) are provided in an enclosure (9) which is firmly mounted to the dip pipe (6) by means of an annular disk (10). The enclosure (9) and the float cup (7) form an annular space (11) which serves as overflow for the water from the float cup (7) and as gas passageway for the coking gas (3). The bottom of the enclosure (9) is also conical, the lower tapered end (9a) having a notched rim (9b) extending into a circular embracing dip seal (12). According to the invention, the enclosure (9) is firmly mounted to the dip pipe (6) via flanged connections (13). In this way, the enclosure (9) and the float cup (7) can be shifted against the crude gas-conducting collecting main (14). The float cup with the enclosure extends into a crude gas-conducting collecting main (14) used to collect the coking gases (3). When the sealing plug (8) is removed from the float cup (7), water flows into the gas collecting main (14), the gas pressure in the coke-oven chamber being controlled by the water level of the dip seal (7b). The upper end of the gas collecting main (14) is fitted with a flap (15), by which the gas collecting main (14) can be shut off against the top. In this way, the gas compartment of the coke-oven chamber can be shut off against the gas collecting main (14) or the gas collecting main against the atmosphere. The flap (15) is closed by upward tilting via the pivot bearing (15a). The water level of the dip seal (7b) of the float cup (7) is regulated via the sealing plug (8) which can be pulled from the water outlet (7a) by using the travelling mechanism of an operating rod (16). When the plug is pulled, the water flows into the gas collecting main (14) through the water outlet (7a). The sealing plug (8) is fitted with a siphon (8a) and a vertically adjustable gate valve (8b) which serves to regulate the level of the dip seal (7b) in the float cup.

FIG. 2 shows the same contrivance in which the float cup (7) is firmly fixed by means of holding rods (17) which are mounted to an annular disk (10) arranged at the dip pipe (6).

FIG. 3 shows a state-of-the-art contrivance which is mounted to the coke-oven chamber. The figure shows the standpipe (2), the dip pipe (6), the crown pipe (6a), the float cup (7) and the gas collecting main (14). Water (18) flows into the dip pipe (6) in the area of the gooseneck and into the gas collecting main (14) through the water outlet (7a). The figure shows the water being discharged (18a). The float cup (7) is fixed to the gas collecting main (14) by means of a suspension device (19). The dip pipe (6) extends into a crown pipe (6a).

### LIST OF DESIGNATIONS AND REFERENCE NUMBERS

1 Device for controlling the coke-oven chamber pressure, control device
2 Standpipe
3 Coking gases
4 Gooseneck
5 Downward flow of coking gases
6 Dip pipe
6a Crown pipe
7 Float cup
7a Water outlet
7b Dip seal with water level
8 Sealing plug
8a Siphon
8b Adjustable gate valve
9 Enclosure
9a Downward tapered lower end of enclosure
9b Notched rim
10 Annular disk
11 Annular space
12 Circular embracing dip seal
13 Flanged connection
14 Gas collecting main
15 Flap
15a Pivot bearing of flap
16 Operating rod for sealing plug
17 Holding rod
18 Inlet water
18a Discharged water
19 Immersion-cup suspension device

1. An apparatus for providing a control device for controlling the gas pressure in a coke-oven chamber without expansion-induced deviations from the control arrangement, including
a standpipe which rises vertically from a coke-oven chamber and is connected to a gooseneck diverting laterally from the standpipe and going over vertically downwards into a dip pipe, the end of which is provided as a crown pipe with indented or notched rims and an inlet for water, and
a float cup with downward tapered bottom, the cup being provided with a water outlet departing from the bottom at its lower end and having an open top, and
a sealing plug travelling through the dip pipe and sealing the discharge from the dip seal of the float cup into the gas collecting main arranged beneath in a controlled manner, and
a crude gas-conducting collecting main into which the water from the float cup flows by overflow or opening of the sealing plug,
wherein;
the float cup and the dip pipe with the crown pipe at its end are contained in a fixed enclosure which forms an annular space with the float cup, this annular space being suited as overflow for the water and gas passage from the float cup into the gas collecting main, and
the enclosure is provided with a notched rim extending into a circular embracing dip seal on top of the gas collecting main so that expansions or misalignments between the gas collecting main and the enclosure can be compensated.

2. The apparatus according to claim 1, wherein the enclosure is made of a cast body or formed sheet metal body.

3. The apparatus according to claim 1, wherein a flanged connection serves to connect the enclosure with the dip pipe.

4. The apparatus according to claim 1, wherein the float cup is suspended by means of holding rods to an annular disk of the dip pipe.

5. The apparatus according to claim 1, wherein the upper opening of the gas collecting main is equipped with a gas flap by which the gas collecting main can be shut off against the enclosure and the float cup.

6. A method for the operation of a coke-oven battery or coke-oven bank including a plurality of coke-oven chambers, a crude-gas conducting crude-gas collecting main and throttle devices installed in the crude-gas collecting main for individual control of the gas pressure in the coking chambers, in which
each of the throttle devices is provided with a water-supplied float cup with sealable outlet, and
the coking chambers are connected to the crude-gas collecting main via gas lines which end as dip pipes in the float cups of the throttle devices, and
throttle devices are used which are provided with an overflow for controlling the liquid level in the float cup, the overflow being vertically adjusted by an actuator,
wherein
the pressure in the coke-oven chamber is controlled by a control device for controlling the gas pressure in a coke-oven chamber without expansion-induced deviations of the float cup and the throttle device from the control arrangement, with expansions towards the gas collecting main being compensated by a circular notched rim of an enclosure dipping into a dip seal.

7. The method according to claim 6, wherein the pressure of at least one coke-oven chamber is controlled by means of a measuring device which adjusts the water supply into the float cup in dependence of the inside pressure of the coke-oven chamber.

8. The method according to claim 6, wherein the circular embracing dip seal is filled with water.

9. The method according to claim 6, wherein the circular embracing dip seal is filled with bitumen.

10. The method according to claim 6, wherein the circular embracing dip seal is provided with a filling containing a silicone compound.

11. The apparatus according to claim 2, characterised in that wherein a flanged connection serves to connect the enclosure with the dip pipe.

12. The apparatus according to claim 2, characterised in that wherein the float cup is suspended by means of holding rods to an annular disk of the dip pipe.

13. The apparatus according to one of claims 2, characterised in that wherein the upper opening of the gas collecting main is equipped with a gas flap by which the gas collecting main can be shut off against the enclosure and the float cup.

14. The method according to claim 7, characterised in that wherein the circular embracing dip seal is filled with water.

15. The method according to claim 7, characterised in that wherein the circular embracing dip seal is filled with bitumen.

16. The method according to claim 7, characterised in that wherein the circular embracing dip seal is provided with a filling containing a silicone compound.
